(19) United States
(12) Patent Application Publication
(10) Pub. No.: US 2008/0084815 A1
(43) Pub. Date: Apr. 10, 2008

(54) METHOD AND APPARATUS OF CONTROL SIGNALING

(75) Inventor: Sung-Huyk Shin, Northvale, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/867,072

(22) Filed: Oct. 4, 2007

Related U.S. Application Data
(60) Provisional application No. 60/828,435, filed on Oct. 6, 2006.

(51) Int. Cl. H04J 11/00; H04B 7/00

(52) U.S. Cl. 370/203; 455/68

(57) ABSTRACT

A method and apparatus of control signaling in an enhanced universal terrestrial radio access (E-UTRA) wireless communication system includes transmitting data-associated control signaling in a first orthogonal frequency division multiplexed (OFDM) symbol of a first slot of an E-UTRA subframe. Data is then transmitted in remaining OFDM symbols of the E-UTRA subframe.

### CROSS REFERENCE TO RELATED APPLICATION

This application claims the benefit of U.S. Provisional Application No. 60/828,435, filed Oct. 6, 2006, which is incorporated herein by reference as if fully set forth.

### FIELD OF INVENTION

The present invention is related to wireless communication systems.

### BACKGROUND

The enhanced universal terrestrial radio access (E-UTRA) system utilizes a transmission time interval (TTI), or subframe, of 1 millisecond. FIG. 1 is a subframe diagram for an E-UTRA TTI, where two 0.5 millisecond slots comprise the entire E-UTRA TTI frame. In general, a baseline allocation includes two consecutive resource blocks (RBs) in time, within a TTI. Additionally, intra-TTI frequency hopping, which is hopping at a slot boundary within a subframe, or TTI, may be considered.

Uplink data associated signaling, (e.g., transport format combination indicator (TFCI) and hybrid automatic repeat request (HARQ) information), should be transmitted to a Node-B prior to transmitting the associated shared data in order to facilitate demodulating and decoding the data correctly, and in a required receive (Rx) timing or latency. For example, in high speed downlink packet access (HSDPA) systems, TFCIs and time-critical information such as modulation type and channelization code set, should be signaled two slots prior to data transmission. TFCI and HARQ information corresponding to a HARQ process is transmitted in a given 1 millisecond TTI. That is, one TFCI/HARQ information per HARQ process.

There is no mechanism, however, for providing control signaling and data. Accordingly, it would be beneficial to provide a method and apparatus of UL control signaling that may be multiplexed with data.

### SUMMARY

A method and apparatus of uplink control signaling are disclosed. The method includes transmitting data-associated control signaling in a first orthogonal frequency division multiplexed (OFDM) symbol of a first slot of an E-UTRA subframe. Data is then transmitted in remaining OFDM symbols of the E-UTRA subframe.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows an example diagram for an E-UTRA subframe;

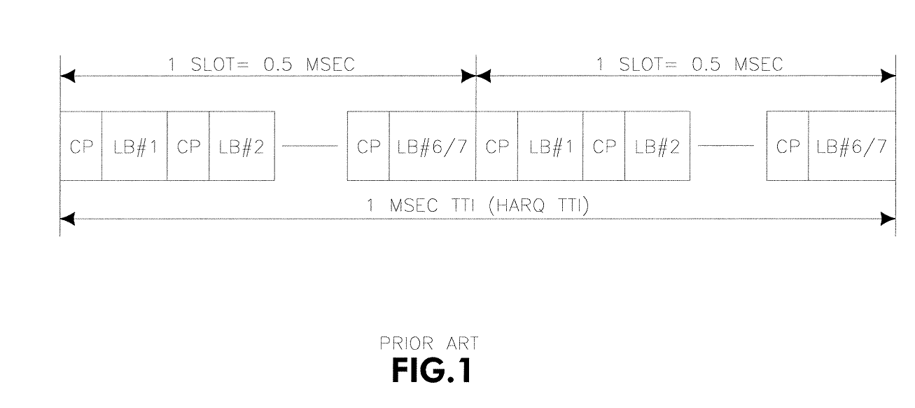

FIG. 2 is an exemplary wireless communication system including a plurality of wireless transmit/receive units (WTRUs), a Node-B, and a radio network controller (RNC);

FIG. 3 is a functional block diagram of a WTRU and the Node-B of FIG. 1;

FIG. 4 is a flow diagram of a method of control signaling; and

FIG. 5 shows an example subframe diagram in accordance with the method of FIG. 4.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to an eNode-B, a Node-B, a site controller, an access point (AP), or any other type of interfacing device capable of operating in a wireless environment.

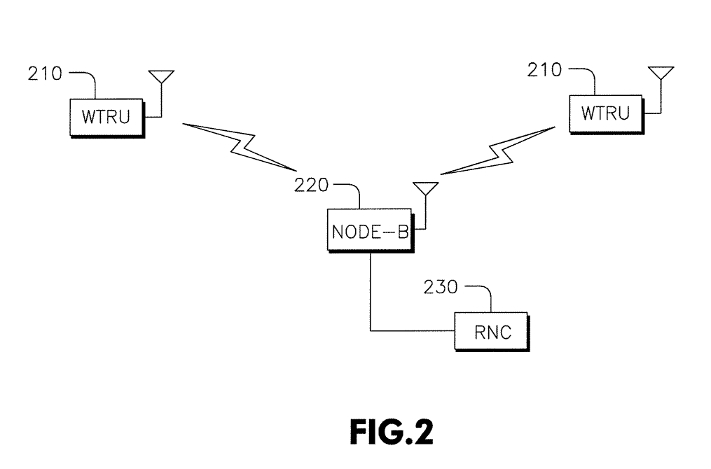

FIG. 2 shows a wireless communication system 200 including a plurality of WTRUs 210, a Node-B 220, and an RNC 230. As shown in FIG. 2, the WTRUs 210 are in communication with the Node-B 220, which is in communication with the RNC 230. Although two WTRUs 210, one Node-B 220, and one RNC 230 are shown in FIG. 2, it should be noted that any combination of wireless and wired devices may be included in the wireless communication system 200.

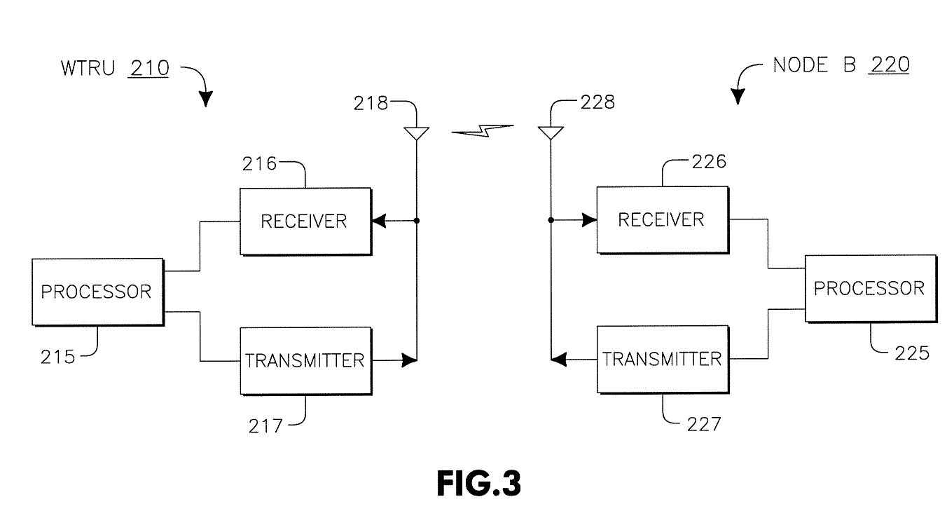

FIG. 3 is a functional block diagram 300 of a WTRU 210 and the Node-B 220 of the wireless communication system 200 of FIG. 2. As shown in FIG. 3, the WTRU 210 is in communication with the base station 220 and both are configured to perform a method of control signaling.

In addition to the components that may be found in a typical WTRU, the WTRU 210 includes a processor 215, a receiver 216, a transmitter 217, and an antenna 218. The processor 215 is configured to perform a method of control signaling. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical Node-B, the Node-B 220 includes a processor 225, a receiver 226, a transmitter 227, and an antenna 228. The processor 225 is configured to perform a method of control signaling. The receiver 226 and the transmitter 227 are in communication with the processor 225. The antenna 228 is in communication with both the receiver 226 and the transmitter 227 to facilitate the transmission and reception of wireless data.

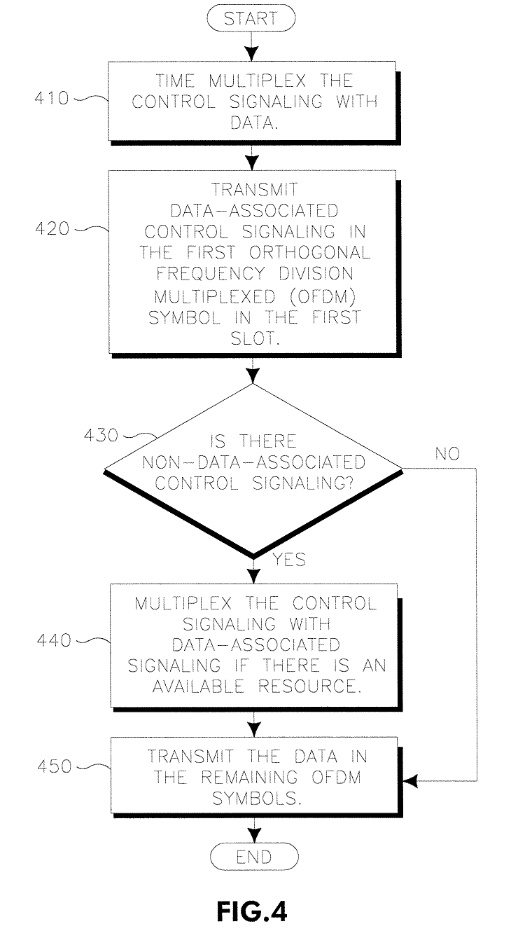

FIG. 4 is a flow diagram of a method 400 of control signaling. The control signaling may be either uplink (UL) control signaling or downlink (DL) control signaling. In step 410, control signaling is time-multiplexed with data on an OFDM symbol level. Data-associated control signaling is transmitted in the first OFDM symbol, which is reserved for data-associated control signaling, in the first slot. Data associated signaling, for example, may include TFCI, such as modulation type and allocated resource blocks (RBs). If necessary, data-associated control signaling may also be transmitted in the second or third OFDM symbol of the first slot.

If there is not any non-data-associated control signaling (step 430), then the method proceeds to step 450. However, if there is non-data-associated control signaling (step 430), then the non-data-associated control signaling may be multiplexed with the data-associated control signaling if there is an available resource for the non-data-associated control signaling (step 440). For example, acknowledgements (ACKs), negative ACKs (NACKs), channel quality indicators (CQI), and the like, may be multiplexed with the data-associated control signaling if RBs or a fraction of an RB, are available. Data is then transmitted in the remaining OFDM symbols (step 450). Additionally, data may be transmitted in the second OFDM symbol if there is an available resource to transmit the data. If resources are unavailable, then non-data-associated control signaling may be spread over the first slot or over two consecutive slots in a subframe.

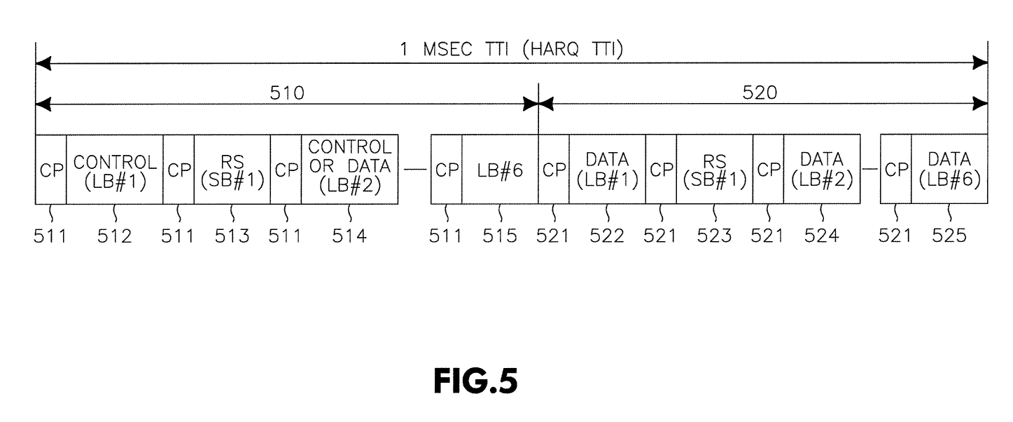

FIG. 5 shows an example subframe diagram 500 in accordance with the method 400 of FIG. 4. As shown in FIG. 5, the subframe diagram 500 is a 1 millisecond (msec) TTI, corresponding to a HARQ TTI. The 1 msec TTI depicted in subframe diagram 500 is separated into a first slot 510 and a second slot 520. Each slot, 510 and 520, is separated into a plurality of RBs, which for purposes of example, may be OFDM symbols, and a plurality of cyclic prefixes (CPs).

For example, slot 510 includes a plurality of CPs 511. After each CP 511 is an OFDM symbol. Some OFDM symbols, (e.g., 512, 514, and 515), are utilized for control signaling or data, while OFDM symbol short block number 1 (SB#1) 513 is utilized for a reference signal (RS). As described above in step 420 of the method 400 of FIG. 4, the first OFDM symbol, long block number 1 (LB#1) 512 is utilized to transmit data-associated control signaling. From the second OFDM symbol on (LB#2-LB#6), either control signaling or data may be transmitted. For example, OFDM symbol 514 may include data-associated control signaling or multiplexed non-data-associated control signaling, if necessary. Otherwise, OFDM symbol 514 may include data.

Slot 520 is substantially similar to slot 510 and includes a plurality of CPs 521. Each CP 521 is followed by an OFDM symbol. Again, some OFDM symbols, (e.g., 522, 524, and 525), are utilized for data, while OFDM symbol SB#1 (523) is utilized for an RS.

Accordingly, the processing latency of the receiver may be reduced by the implementation of method 400 of FIG. 4, and a single-carrier waveform may be preserved. Furthermore, peak to average power ratio (PAPR) should be low. The implementation of the method 400 of FIG. 4 may also facilitate application of transmit power control (TPC) and adaptive modulation and coding (AMC) for control signaling.

Although features and elements are described above in particular combinations, each feature or element can be used alone without the other features and elements or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of control signaling in an enhanced universal terrestrial radio access (E-UTRA) wireless communication system, the method comprising:
transmitting data-associated control signaling in a first orthogonal frequency division multiplexed (OFDM) symbol of a first slot of an E-UTRA subframe; and
transmitting data in remaining OFDM symbols of the E-UTRA subframe.

2. The method of claim 1 wherein data-associated control signaling includes a transport format combination indicator (TFCI) signaling.

3. The method of claim 1 wherein data-associated control signaling includes hybrid automatic repeat request (HARQ) process signaling.

4. The method of claim 1 wherein data-associated control signaling includes a modulation type.

5. The method of claim 1 wherein data-associated control signaling includes a resource block (RB) allocation.

6. The method of claim 1 further comprising multiplexing non-data-associated control signaling with the data-associated control signaling.

7. The method of claim 6 wherein the non-data-associated control signaling includes acknowledgements (ACKs).

8. The method of claim 6 wherein the non-data-associated control signaling includes a channel quality indicator (CQI).

9. The method of claim 1, further comprising transmitting data-associated control signaling in a second OFDM symbol of the E-UTRA subframe.

10. The method of claim 9, further comprising multiplexing non-data-associated control signaling with the data-associated control signaling in the second OFDM symbol of the E-UTRA subframe.

11. The method of claim 1 wherein the control signaling is uplink (UL) control signaling.

12. The method of claim 1 wherein the control signaling is downlink (DL) control signaling.

13. A wireless transmit/receive unit (WTRU), the WTRU comprising:
a receiver;
a transmitter; and
a processor in communication with the receiver and the transmitter, the processor configured to transmit data-associated control signaling in a first orthogonal frequency division multiplexed (OFDM) symbol of a first slot of an E-UTRA subframe, and transmit data in remaining OFDM symbols of the E-UTRA subframe.

14. The WTRU of claim 13 wherein the processor is further configured to multiplex non-data-associated control signaling with the data-associated control signaling.

15. The WTRU of claim 13 wherein the processor is further configured to transmit data-associated control signaling in a second OFDM symbol of the E-UTRA subframe.

16. The WTRU of claim 15 wherein the processor is further configured to multiplex non-data-associated control signaling with the data-associated control signaling in the second OFDM symbol of the E-UTRA subframe.

17. A Node-B, the Node-B comprising:
a receiver;
a transmitter; and
a processor in communication with the receiver and the transmitter, the processor configured to transmit data-associated control signaling in a first OFDM symbol of a first slot of an E-UTRA subframe, and transmit data in remaining OFDM symbols of the E-UTRA subframe.

18. The Node-B of claim 17 wherein the processor is further configured to multiplex non-data-associated control signaling with the data-associated control signaling.

19. The Node-B of claim 17 wherein the processor is further configured to transmit data-associated control signaling in a second OFDM symbol of the E-UTRA subframe.

20. The Node-B of claim 19 wherein the processor is further configured to multiplex non-data-associated control signaling with the data-associated control signaling in the second OFDM symbol of the E-UTRA subframe.
